(19) United States
(12) Patent Application Publication
(10) Pub. No.: US 2009/0260477 A1
(43) Pub. Date: Oct. 22, 2009

(54) CYCLE SHOE AND CONNECTOR

(76) Inventor: Gavin G. Railing, Scottsburg, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/426,684

(22) Filed: Apr. 20, 2009

Related U.S. Application Data
(62) Division of application No. 61/046,528, filed on Apr. 21, 2008.

(51) Int. Cl. B62M 3/00

(52) U.S. Cl. 74/594.6

(57) ABSTRACT

The present invention provides a shoe which can be worn for pedaling a bicycle and also for walking, jogging, and running. The pedal includes a body that has a first coupling element and a second coupling element. The first coupling element is disposed substantially near the toe end of the body and the second coupling element is disposed substantially near the heel end of the body. The first coupling element and second coupling element are adapted to couple to a shoe. In another embodiment, a method is provided for coupling a shoe to a pedal of a bicycle.

### RELATED APPLICATIONS

This application claims priority to U.S. Provisional Patent Application No. 61/046,528, filed Apr. 21, 2008, which is hereby incorporated by reference.

### BACKGROUND

The present invention relates to a shoe, and in particular a shoe that can couple to a bike pedal.

Many bicycles are designed with pedal assemblies that include a fastener strap or connector for securing a rider's foot to the pedal. This is especially the case with competitive bicycles in which the pedal couples to the shoe being worn by the rider. Such shoes generally include a platform that protrudes from the bottom of the shoe and which locks to the pedal to prevent the rider's foot from slipping from the pedal as the rider pedals.

In many instances, the shoe locks to the pedal via screws or bolts that screw into the bottom of the platform. The platform may protrude an inch or more from the bottom sole of the shoe and makes attempting to walk, jog, or run extremely difficult and dangerous. Since the platform is part of the shoe, a rider must remove the shoe and change into another shoe without the platform before attempting to walk, jog, or run. In sporting events such as triathlons, for example, having to disconnect the shoe from the pedal and then changing shoes is time-consuming and may be the difference between a participant winning and losing the sporting event.

Therefore, a need has arisen for providing a shoe that may couple to a pedal and which, once removed from the pedal, can still be worn by the user to walk, jog, and/or run. Further, a need has arisen for being able to easily de-couple the shoe from the pedal.

### SUMMARY OF THE INVENTION

The present invention addresses the disadvantages of the prior art by providing a shoe which can couple to a platform or body of a bicycle pedal, wherein the shoe can be decoupled from the pedal and immediately worn while walking, jogging, and/or running. In this arrangement, the shoe is not fixedly coupled to the pedal such that fasteners or other hardware has to be removed before the shoe is decoupled from the pedal. This can be advantageous for triathletes who can quickly couple or decouple their shoes to or from the pedal, respectively, and immediately proceed to the next event of competition.

In a first aspect of the invention, a pedal of a bicycle is provided. The pedal comprises a body having a toe end and a heel end. The body further includes a first coupling element disposed substantially near the toe end of the body and a second coupling element disposed substantially near the heel end of the body. The first coupling element and second coupling element are both adapted to couple to a shoe.

In another form thereof, a method for coupling a shoe to a pedal of a bicycle is provided. The method includes coupling the shoe to a first coupling element of the pedal and a second coupling element. The shoe can be coupled to the first coupling element by inserting the first coupling element into a corresponding opening of the shoe. The shoe can also be pivoted for coupling to the pedal. The shoe can be coupled to the second coupling element by inserting the second coupling element into a corresponding opening of the shoe. Once the shoe is coupled to the pedal, the shoe is not fixedly coupled to the pedal. Instead, the shoe can be quickly decoupled from the pedal without having to remove fasteners, for example.

In a different aspect, a shoe is provided for coupling to a pedal of a bicycle. The pedal includes a first coupling element and a second coupling element. The shoe includes an outer frame shaped for receiving a foot. Also, the shoe has a bottom surface that defines a receiving element which is configured for coupling to the first coupling element. Further, a side wall of the frame defines an opening which is configured for receiving the second coupling element. When the receiving element is coupled to the first coupling element and the opening receives the second coupling element, the shoe is coupled to the pedal.

These and other features, aspects and advantages of the present invention will become better understood with reference to the following drawings, description and claims.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a perspective view of a body which couples to a pedal and which a shoe may couple to the body;

FIG. 2 is a side view of the body and pedal of FIG. 1;

FIG. 3 is a side view of an exemplary shoe for coupling to the body of FIG. 1;

FIG. 4 is a bottom view of the show of FIG. 3; and

FIG. 5 is a side view of the shoe of FIG. 3 coupled to the body of FIG. 1.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Broadly, the present invention provides a shoe that may be worn by a rider of a bicycle, unicycle, or the like. The shoe may further couple to a pedal to help prevent the rider's foot from slipping or sliding off the pedal when a rider is pedalling. The pedal can include a body or platform which couples to a crankshaft of the pedal. In this arrangement, the shoe can couple to the body or platform, but via this coupling, the shoe is not locked or fixedly coupled to the body or platform. Instead, the shoe can be easily and quickly decoupled from the body or platform.

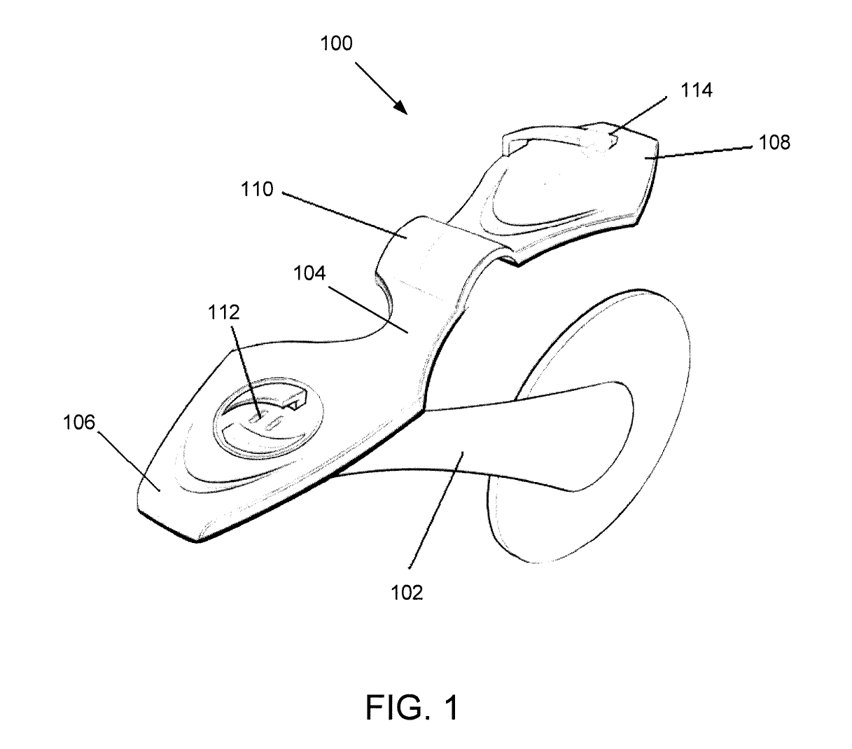

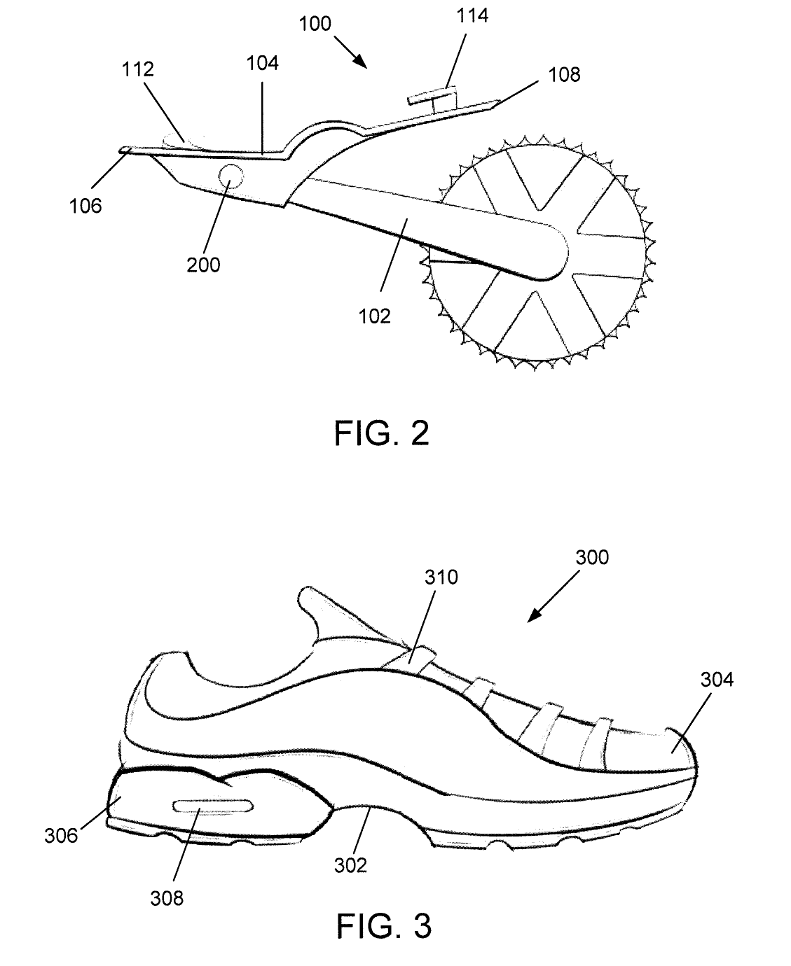

With reference to FIG. 1, an exemplary embodiment of a bike pedal 100 is provided. The bike pedal 100 can include a crankshaft 102 and a platform or body 104. The crankshaft 102 can couple to the platform or body 104 via a fastener (not shown) that passes through an opening 200 (see FIG. 2) in the platform or body 104. The platform or body 104 has a toe end 106 and a heel end 108 that correspond to the location of the rider's toes and heel when positioned on the platform or body 104.

The platform or body 104 can be any desired shape or size. In the embodiment of FIG. 1, the platform or body 104 has a shape and size similar to the bottom of a shoe that can couple thereto. For example, an arch support 110 may be provided in the design of the platform or body 104. In FIG. 3, an exemplary shoe 300 is shown. The arch support 110 of the platform or body 104 can be designed such that the shape of the arch portion 302 of the shoe 300 fits comfortably over the arch support 110. Advantageously, the design of the platform or body 104 is both aesthetically pleasing and comfortable to the rider when the shoe is coupled thereto.

The platform or body 104 can also be stiff and light weight. For example, the platform or body 104 may weigh between 0.5-5 lbs depending on the size, shape, and material used to manufacture the platform or body 104. The stiffness of the platform or body 104 can further enhance the pedalling effort that the rider puts forth. In various embodiments, the platform or body 104 can be made of titanium, carbon fiber, aluminum, or any other light weight material that may be known to the skilled artisan.

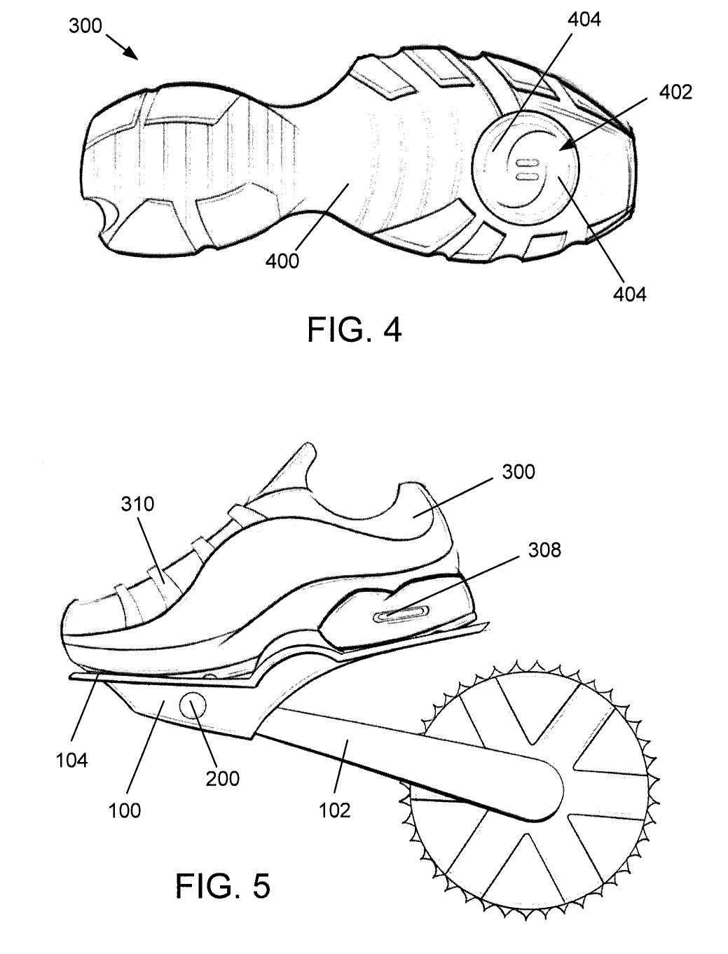

Near the toe end 106 of the platform or body 104 is a first coupling element 112. In the embodiment of FIG. 1, the first coupling element 112 protrudes from the top surface of the platform or body 104 and forms 90° radial tabs. In this embodiment, the first coupling element 112 can comprise two 90° radial tabs that protrude from the platform or body 104. To couple the shoe 300 to the toe end 106 of the platform or body 104, the bottom surface 400 of the shoe 300 can include a corresponding receiving element 402 for receiving the first coupling element 112 of the platform or body 104. With reference to FIG. 4, the receiving element 402 can include slots or openings 404 which correspond to the radial tabs of the first coupling element 112. The slots or openings 404 can be similarly shaped as the first coupling element 112 such that a rider positions the shoe 300 upon the platform or body 104 in a manner that the first coupling element 112 is inserted into the slots or openings 404 of the receiving element 402.

Once the first coupling element 112 engages or passes through the receiving element 402, the shoe 300 can be pivoted such that the first coupling element 112 moves internally within the sole of the shoe 300 as the first coupling element 112 is coupled to the receiving element 402. In the coupled position, the toe end 304 of the shoe 300 is pointing substantially towards the front of the bike (e.g., the toe end 106 of the pedal 100) and the heel end 306 of the shoe 300 is pointing substantially towards the rear of the bike (e.g., the heel end 108 of the pedal 100). In this arrangement, the rider is able to pedal the bike without the toe end 304 of the shoe 300 decoupling from the first coupling element 112 of the platform or body 104.

As also shown in FIG. 1, the heel end 108 of the platform or body 104 can include a second coupling element 114. The second coupling element 114 can include a tab that protrudes from the top surface of the platform or body 104 and extends transverse to the length of the platform or body 104. The tab can be elastic or stiff and made from titanium, carbon fiber, aluminum, or other similar material known to the skilled artisan. In the embodiment of FIG. 1, the shoe 300 can first be coupled to the platform or body 104 by coupling the receiving element 402 of the shoe 300 to the first coupling element 112. This is not intended to be limiting, however, and in alternative embodiments the second coupling element 114 can couple to the platform or body 104 first. However, in FIG. 1, once the first coupling element 112 is coupled to the shoe 300, the second coupling element 114 can slide or be inserted into a corresponding opening 308 in the shoe 300 (see FIG. 3).

In the shoe 300 of FIG. 3, the opening 308 is defined within a side wall of the shoe 300. As the first coupling element 112 engages the corresponding opening 404 on the bottom surface 400 of the shoe 300 and the shoe 300 is pivoted to further couple the first coupling element 112 to the shoe 300. As the shoe 300 is pivoted to the coupled position, the second coupling element 114 can move into the opening 308 of the shoe 300 to couple the heel end 306 of the shoe 300 to the platform or base 104. In FIG. 5, the shoe 300 is coupled to the first coupling element 112 and second coupling element 114 of the platform or base 104.

The first coupling element 112 and second coupling element 114 are not limited to the embodiment of FIGS. 1-5. Instead, there can be a plurality of twist-like tabs for coupling the toe end 304 of the shoe 300 to the platform or body 104. In a different embodiment, the toe end 304 and heel end 306 of the shoe 300 can include a snap-fit connector that snaps into the first coupling element 112 and second coupling element 114. In another embodiment, the first coupling element 112 may comprise a tab similar to the second coupling element 114 of FIGS. 1 and 2 that extends transverse to the length of the platform or body 104 and can be moved or inserted into a corresponding slot or opening in the side of the shoe 300 similar to the slot or opening 308 in FIG. 3. Other embodiments for coupling the shoe 300 to the platform or body 104 known to one skilled in the art may be used so long as the shoe is not fixedly coupled to the platform or body 104. The shoe 300 should be easy to decouple from the platform or body 104 and be available for walking, jogging, and running immediately after the shoe 300 is removed from the platform or body 104.

Although not shown, the first coupling element can also include a plurality of members or posts that protrude from the top surface of the platform or body 104. These members or posts (not shown) can have a T-shaped design, for example, or any other design known to a skilled artisan. In this particular embodiment, the sole of the shoe 300 can also include a plurality of openings that are connected to slots or channels within the sole. The members or posts can be inserted into the openings, and then to couple the shoe 300 to the platform or body 104, the shoe 300 can then be moved to slide the members or posts (not shown) into the slot or channel (not shown) within the sole of the shoe.

Further, for the shoe 300 to also be used for walking, jogging, and/or running, the slots or channels in the sole of the shoe 300 should be closed to prevent rocks, sand, dirt, and other objects from entering the slots or channels and making the shoe uncomfortable to the wearer. To achieve this, the slots or openings can be closed by a spring-biased cap (not shown) that is in the closed position when the shoe 300 is not coupled to the platform or body 104. When the shoe 300 is being coupled to the platform or body 104, the cap (not shown) can be slid in an inward direction (transverse to the length of the shoe) to compress a spring (not shown) that is coupled to the cap (not shown) and allow the member or post (not shown) to enter the opening and be moved through the unobstructed slot or channel. The cap (not shown) can latch to a clip (not shown), for example, in the opened position to remain open as the shoe 300 is coupled to the platform or body 104. A spring-biased cap (not shown) can also be used to block the opening 308 which couples to the second coupling element 114.

In an alternative embodiment, the first coupling element 112 and second coupling element 114 can comprise straps (not shown) that can be folded over the shoe 300 and include Velcro® for coupling the shoe 300 to the platform or body 104. Other embodiments known to a skilled artisan may be incorporated with the straps for coupling the shoe 300 to the platform or body 104 so long that the shoe 300 can be removed quickly from the pedal 100.

As described above, the shoe 300 can include openings, slots, channels, buttons, snap-fit connectors, or the like that allow the shoe 300 to be coupled to the platform or body 104. The shoe 300 can also be removed from the platform or body 104 quickly without having to remove fasteners like nuts and bolts, although in other embodiments it may be desirable to slidably couple the shoe 300 to the platform or body 104 via fasteners. The shoe 300 can be made from a flexible material that is comfortable for the user to wear while pedalling a bicycle and/or walking, jogging, and running. The shoe soles can be made from rubber, although the soles should not be limited to any particular material so long as the soles are flexible for walking, jogging, and running. Additionally, in an exemplary embodiment, the shoe 300 can include lacing 310 (see FIG. 3) in the form of bungee material that allows the shoe 300 to be tightened by pulling a string or lacing through a tightening mechanism (not shown). In other embodiments, the lacing 310 can comprise a strap having Velcro® on one side and that passes through a slot in the shoe 300, folds over, and is held in place by the Velcro® material. In another embodiment, the lacing 310 can comprise string similar to that which is used with tennis shoes and the lacing 310 can be tied for tightening the shoe around the rider's foot.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A pedal of a bicycle, comprising:
a body having a toe end and a heel end;
a first coupling element disposed substantially near the toe end of the body;
a second coupling element disposed substantially near the heel end of the body;
wherein, the first coupling element and second coupling element are both adapted to couple to a shoe.

2. The pedal of claim 1, wherein the first coupling element comprises a plurality of radial tabs.

3. The pedal of claim 1, wherein the second coupling element comprises a tab that protrudes away from the body and extends transverse to the length of the pedal.

4. The pedal of claim 1, wherein the body comprises an arch between the toe end and heel of the body.

5. The pedal of claim 1, wherein the body is coupled to a crankshaft of the bicycle.

6. The pedal of claim 1, wherein the first coupling element is configured to be received by an opening in a bottom of the shoe.

7. The pedal of claim 1, wherein the second coupling element is configured to be received by an opening in a side of the shoe.

8. The pedal of claim 1, wherein the first coupling element and second coupling element are adapted to not be fixedly coupled to the shoe.

9. The pedal of claim 1, wherein the body comprises titanium, carbon fiber, or aluminum.

10. The pedal of claim 1, wherein the second coupling element comprises titanium, carbon fiber, or aluminum.

11. The pedal of claim 1, wherein the body is configured to be similarly shaped as a bottom surface of a shoe.

12. A method for coupling a shoe to a pedal of a bicycle, comprising:
coupling the shoe to a first coupling element of the pedal; and
coupling the shoe to a second coupling element of the pedal.

13. The method of claim 12, wherein the coupling the shoe to a first coupling element comprises inserting the first coupling element into a corresponding opening of the shoe.

14. The method of claim 13, further comprising pivoting the shoe to couple the shoe to the pedal.

15. The method of claim 12, wherein the coupling the shoe to a second coupling element comprises inserting the second coupling element into a corresponding opening of the shoe.

16. The method of claim 12, wherein, when the shoe is coupled to the first coupling element and second coupling element, the shoe is not fixedly coupled to the pedal.

17. The method of claim 12, wherein, when the shoe is coupled to the pedal, the toe end of the shoe is positioned substantially above the toe end of the pedal and the heel end of the shoe is positioned substantially above the heel end of the pedal.

18. The method of claim 12, wherein the shoe is coupled to the first coupling element before the shoe is coupled to the second coupling element.

19. A shoe for coupling to a pedal of a bicycle, the pedal having a first coupling element and a second coupling element, comprising:
an outer frame shaped for receiving a foot;
a bottom surface of the frame defining a receiving element, the receiving element being configured for coupling to the first coupling element; and
a side wall of the frame defining an opening, the opening being configured for receiving the second coupling element.

20. The shoe of claim 19, wherein, when the receiving element is coupled to the first coupling element and the opening receives the second coupling element, the shoe is coupled to the pedal.
